(19) United States
(12) Patent Application Publication
(10) Pub. No.: US 2023/0381045 A1
(43) Pub. Date: Nov. 30, 2023

(54) Vertical Vibration Platform

(71) Applicant: William Cabrera Borja, San Diego, CA (US)

(72) Inventor: William Cabrera Borja, San Diego, CA (US)

(21) Appl. No.: 18/204,346

(22) Filed: May 31, 2023

Related U.S. Application Data
(60) Provisional application No. 63/347,172, filed on May 31, 2022.

(51) Int. Cl. A61H 1/00

(52) U.S. Cl. CPC A61H 1/005; A61H 23/0263

(57) ABSTRACT

A vibrating platform is described. The vibrating platform may include a flat top surface that allows a user to, for example, place both feet on the platform during use. The vibrating platform may include user interface (UI) elements such as a power switch, intensity control, display, and/or other appropriate elements that may allow a user to adjust operation of the vibrating platform and/or receive information regarding current settings and/or operating parameters.

### CROSS-REFERENCE TO RELATED APPLICATIONS

This application claims priority to U.S. Provisional Patent Application Ser. No. 63/347,172, filed on May 31, 2022.

### BACKGROUND

Existing vibration plates include plates with limited load bearing capacity and usable area. Users are not able to, for example, utilize equipment (e.g., weights, racks, benches, etc.) with the vibration plates. Further, various movements may be limited by the usable area of the existing vibration plates such that, for example, a desired range of motion is not able to be realized.

Thus there is a need for a vibration platform with increased load bearing capacity and usable area.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates a top plan view of an exemplary vibration platform of one or more embodiments described herein;

FIG. 2 illustrates a top plan view of the vibration platform of FIG. 1 where the housing is omitted such that components of the vibration platform are visible;

FIG. 3 illustrates a section view of the vibration platform of FIG. 1;

FIG. 4 illustrates a front elevation view of a vibrating element of the vibration platform of FIG. 1;

FIG. 5 illustrates a front elevation view of an alternative vibrating element of the vibration platform of FIG. 1;

FIG. 6 illustrates a front elevation view of another alternative vibrating element of the vibration platform of FIG. 1;

FIG. 7 illustrates a closeup side elevation view of a portion of the vibration platform of FIG. 1;

FIG. 8 illustrates a top, front, right-side perspective view of the vibration platform of FIG. 1;

FIG. 9 illustrates a top plan view of another exemplary vibration platform of one or more embodiments described herein;

FIG. 10 illustrates a section view of the vibration platform of FIG. 9;

FIG. 11 illustrates a closeup side elevation view of a portion of the vibration platform of FIG. 9;

FIG. 12 illustrates a top, front, right-side perspective view of the vibration platform of FIG. 9;

FIG. 13 illustrates a top plan view of another exemplary vibration platform of one or more embodiments described herein;

FIG. 14 illustrates a section view of the vibration platform of FIG. 13;

FIG. 15 illustrates a closeup side elevation view of a portion of the vibration platform of FIG. 13;

FIG. 16 illustrates a top, front, right-side perspective view of the vibration platform of FIG. 13;

FIG. 17 illustrates a schematic block diagram of an exemplary environment associated with the vibration platform of FIG. 1;

FIG. 18 illustrates a flow chart of an exemplary process that manages vibration;

FIG. 19 illustrates a flow chart of an exemplary process that provides user interface features; and

FIG. 20 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a vibrating platform. The vibrating platform may include a flat top surface that may allow a user to, for example, place both feet on the platform during use. The vibrating platform may include user interface (UI) elements such as a power switch, intensity control, display, and/or other appropriate elements that may allow a user to adjust operation of the vibrating platform and/or receive information regarding current settings and/or operating parameters.

Vibration (or “vibrational”) plates or platforms may be used to stimulate muscles during various exercises or treatments, such as fitness, cardio, strength, conditioning, endurance, functional, movement; rehabilitation, balance, coordination, athletic; interval; boxing, kick-boxing, mixed martial arts (MMA), and/or other types of training across various ranges of size, fitness, strength, motion, etc. Other benefits of vibration plates may include; for example improved sleep, endurance, strength, power, recovery, balance, circulation, coordination, etc.

A vibration platform may include one or more vibration plates. As the body of a user contacts the vibration plate, the muscles are stimulated and must contract and stretch to steady the user in response to the vibration, resulting in a more rigorous workout.

A vertical vibration platform of some embodiments may include structural materials such as, but not limited to, aluminum, steel, as well as being available an array of shapes and sizes to benefit a broader user base.

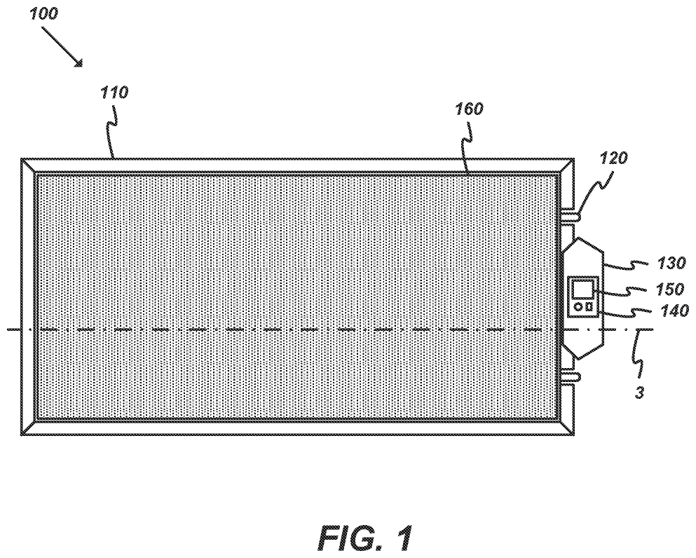

FIG. 1 illustrates a top plan view of an exemplary vibration platform 100 of one or more embodiments described herein. As shown, the vibration platform 100 may include a housing 110, a set of wheels 120, a manager mount 130, a platform manager 140, various UI elements 150, a surface mat 160, and/or other appropriate elements.

This example vibration platform 100 is rectangular in shape in order to maximize usable surface area and has a grid pattern underneath the platform made of stronger materials that contribute to a more structurally sound platform that can withstand greater weight and more rigorous exercise. Other embodiments of the vibration platform 100 may have variations in shape and/or size to better accommodate movement for any given situation.

Housing or “cover” 110 may include elements such as sheet metal (e.g., aluminum, steel, etc.), plastics, resin, wood, composites, and/or other appropriate materials. As one example, cover 110 may include one-quarter inch thick aluminum sheet metal sections that are welded together. Housing 110 may include a flat “platform”, “plate”, “vibration plate”, vibration platform”, or “top deck” area at least partly surrounded by a sloped and mitered skirt in this example. The skirt of housing 110 may include materials such as plastic, metal, rubber, foam, etc. and may serve the purposes of both aesthetics and safety. The angle and length of the skirt may vary based on the application or the user needs. In some cases, the skirt may also provide additional stability for the vibration platform 110, and/or elements thereof.

In some embodiments, housing 110 may include and/or be coupled to a feature such as a grip or handle (e.g., a pair of recesses along the skirt opposite the wheels 120, a “T” or “U” handle bolted to the skirt opposite the wheels 120, a rope or strap coupled to the skirt, etc.).

Each wheel 120 may include materials such as nylon, plastic, metal, rubber, and/or other appropriate materials. Wheels 120 may allow the vibration platform 100 to be easily moved by lifting the end opposite to the wheels 120. In some embodiments, the wheels 120 may be extendable and/or retractable such that the wheels 120 may be extended past, for example, a bottom edge of housing 110 during movement of the vibration platform 100 and retracted to a position above supports 220 for stationary use of the vibration platform 100.

Manager mount 130 may be coupled to the housing 110 in various appropriate ways (e.g., via one or more angled brackets, using fasteners such as bolts or screws, via welded connections, and/or other appropriate ways). In some embodiments, the manager mount 130 and housing 110 may be formed from a single structural element (e.g., a section of sheet metal, a molded plastic element, etc.). Manager mount 130 may include a recess, cavity, receptacle, and/or other similar element that may be able to accept at least a portion of the platform manager 140 (e.g., a rectangular opening in a section of manager mount 130). In this example, manager mount 130 includes a “brow” that couples to a portion the skirt of housing 110.

Platform manager 140 may be, include, and/or utilize various electromechanical components. For instance, platform manager 140 may include a controller or processor and motor driver circuitry. Platform manager 140 will be described in more detail in reference to environment 1700 below.

UI elements 150 may include elements such as buttons, keypads, displays, touchscreens, touchpads, rotary controls, haptic feedback, speakers, microphones, motion sensors, etc. In this example, the UI elements 150 may include an on/off switch, a frequency controller for the speed and/or power of the vibrations being produced, and a digital or analog display. Such a simplified interface may allow ease of use and minimize cost and complexity of elements such as the platform manager 140. UI elements 150 may allow control of various operating attributes of the vibration platform 100, such as intensity or power of vibrations, frequency of vibration, vibration attributes such as duty cycle or wave shape, usage type (e.g., exercise, weighted exercise, massage, treatment, therapy, etc.). UI elements 150 may provide indications as to various control or operational settings (e.g., by indicating vibration frequency, power, wave type, etc.).

Surface mat 160 may be coupled to the flat top deck or platform of the vibration platform 100 and may include different materials for different applications such as a rubber nonslip surface, a smooth hard surface, or a soft foam pad to optimize performance under various usage scenarios.

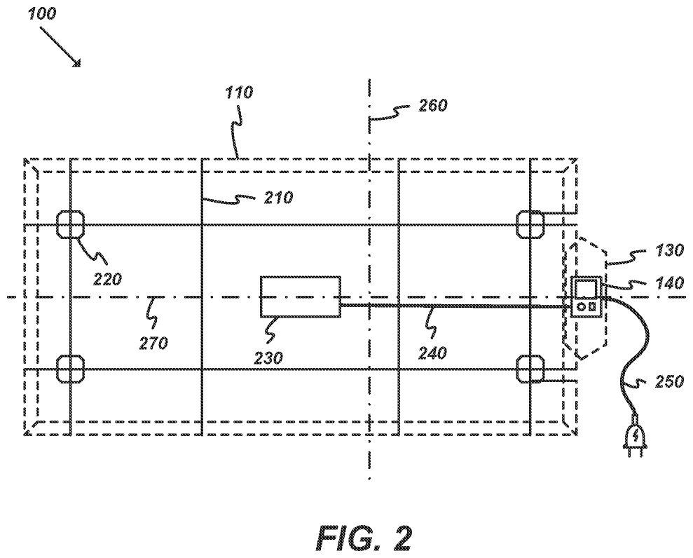

FIG. 2 illustrates a top plan view of the vibration platform 100 where the housing 110 is omitted such that components of the vibration platform 100 are visible. As shown, the vibration platform 100 may include a frame 210, supports 220, vibration element 230, cabling 240, a power coupling 250, and/or other appropriate components.

Frame 210 may include structural members such as a lattice of linear stiffener plates arranged in parallel and perpendicular orientations as shown. Frame 210 may be made from materials such as metal (e.g., aluminum, steel, etc.), plastic, wood, etc. In this example, frame 210 may include sections of one-quarter inch thick sheet metal that are welded together in the arrangement shown. Portions of the frame 210 may be coupled to cover 110 in various appropriate ways (e.g., via welded connections, using various fasteners, adhesives, etc.).

Each support or “pad” 220 may include a flat bottom surface that may contact an external support such as flooring and be able to retain the vertical vibration platform 100 at a given location during use. Each support 220 may be coupled to the frame 210 (e.g., via adhesive, fasteners, compression fit, etc.). As shown, each support 220 may be located at an intersection of structural members of the frame 210 such that structural integrity and load-bearing capability of the vibration platform 100 is optimized. Some embodiments may have adjustable supports 220, where the height of the support 220 (and associated portion of the vibration platform 100) may be increased or decreased, for use on uneven surfaces or to tilt the vibration platform 100 in a given direction to increase or decrease the difficulty of a given exercise.

Vibration element 230 may be an electromechanical component that is able to generate vibrational motion (e.g., linear motion) along an axis perpendicular to the top deck of vibration platform 100.

Cabling 240 may include wiring, connectors, cables, and/or other appropriate elements that may allow components of vibration platform 100 to interact (e.g., via a local communication bus) and/or share or utilize resources (e.g., power supplies). In some embodiments, cabling 240 may include wireless communication channels (e.g., Bluetooth) and/or power transfer channels (e.g., electromagnetic connections).

Power coupling 250 may include various cables, connectors, etc. that may allow the vibration platform 100 to receive power from an external source such as a wall outlet. In some embodiments, vibration platform 100 may include storage elements such as batteries that may allow the vibration platform 100 to be utilized when an external power source is not available.

Vertical axis 260 may be parallel to the vertical (in this view) beams of frame 210. Horizontal axis 270 may be perpendicular to the vertical axis 260 and may be parallel to the horizontal (in this view) beams of frame 210. Each “beam” or “structural member” may have a set of notches to engage complementary notches in a perpendicular beam in some embodiments. In some embodiments, each “beam” may include multiple sub elements that are joined together (e.g., sections of sheet metal may be welded together at each joint or junction of the frame 210). In this example, each beam may have a mitered end to match the slope of the skirt of housing 110.

In some embodiments, vibration platform 100 (or portions thereof, such as housing 110 and frame 210) may be symmetrical about the horizontal axis 270 as shown. In this example, the position of cabling 240 has been offset for clarity, and may run along horizontal axis 270 in some embodiments.

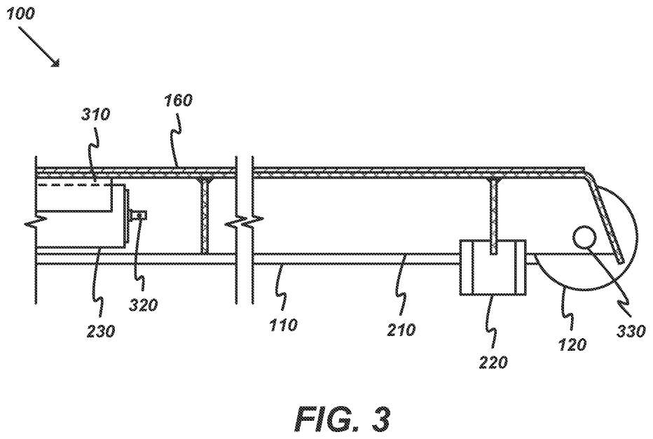

FIG. 3 illustrates a section view of the vibration platform 100. As shown, vibration element 230 may be associated with a mounting feature 310 and may include a rotary shaft 320. In addition, each wheel 120 may be coupled to frame 210 via an axle 330.

Mounting feature 310 may include various fasteners, adhesives, and/or other appropriate elements that may securely couple the vibration element 230 to the housing 110, frame 210, and/or other appropriate elements of vibration platform 100. Mounting feature 310 may include various gaskets or fittings that may allow the typically round vibration element 230 to be securely coupled to a flat surface, such as the underside of the top deck of housing 110.

Rotary shaft 320 may rotate about a center axis of the motor 230 and may include various coupling features, such as threaded portions, shaped portions (e.g., a polygonal outline), holes or recesses, fasteners, etc. that may allow various offset weights to be attached to the shaft 320 such that rotary movement is converted to vibrational movement.

Each axle 330 may include rigid materials such as metal or plastic and may include various other appropriate components (e.g., bearings) that allow for rotational movement of wheels 120. As shown, the supports 220 and wheels 120 may be arranged such that the wheels do not contact the ground or floor when the vibration platform 100 is on a flat surface, but, due to proximity to the edge of housing 110, the wheels 120 will contact the ground when the opposite end of the vibration platform 100 is sufficiently raised.

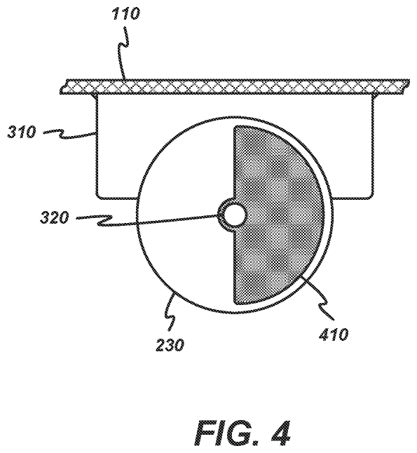

FIG. 4 illustrates a front elevation view of a vibrating element 230 of the vibration platform 100. As shown, vibration element 230 may include an offset weight 410. In this example, offset weight 410 has a semicircle shape.

In this example, mounting feature 310 may have a rigid structure, such as welded or bent sheet metal that is formed into a box shape with a rounded cavity, as shown. Such a rigid structure may effectively transfer vibrational movement from the vibration element 230 to the housing 110 (or the top deck portion thereof). The vibration element 230 may be coupled to the mounting element 310 using various appropriate fasteners, connectors, straps, clamps, adhesives, welded connections, etc. The mounting feature 310 may be securely coupled to the housing 110 via a welded connection, various fasteners (e.g., nuts, bolts, screws, adhesives, etc.).

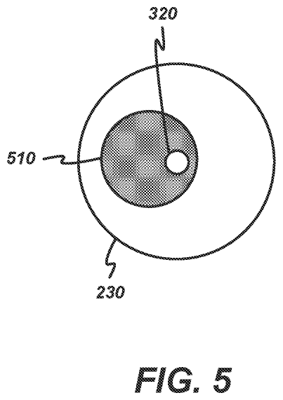

FIG. 5 illustrates a front elevation view of an alternative vibrating element 230 of the vibration platform 100. As shown, vibrating element 230 may include an alternative offset weight 510. In this example, offset weight 510 has a cylindrical shape, with an off-center mounting hole as shown.

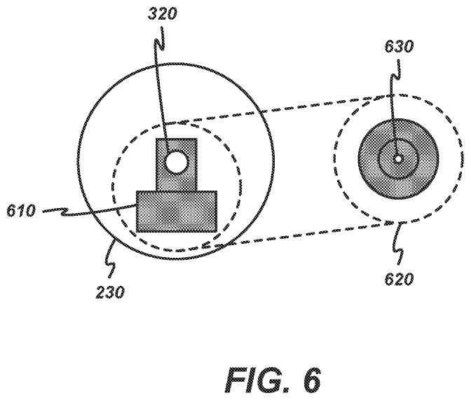

FIG. 6 illustrates a front elevation view of another alternative vibrating element of the vibration platform 100. As shown, vibrating element 230 may include an alternative offset weight 610. The alternative offset weight 610 is also illustrated in a top plan view 620 showing a set screw recess 630 that may be used to fasten the offset weight 610 to the rotary shaft 320. In this example, offset weight 610 has a cylindrical connector or offset element that is coupled to another cylindrical (or disc-shaped) element, as shown.

Each offset weight 410, 510, or 610 may be made from metal and/or other appropriate materials and may be sized based on the capabilities of vibration element 230 (e.g., power, size, etc.), attributes of the vibration platform 100 (e.g., platform size, weight capacity, etc.), and/or other relevant factors. For example, offset weights 410, 510, and/or 610 may have greater mass when associated with larger platforms. Some embodiments of the vibration platform 100 may include multiple offset weights 410, 510, or 610 coupled to the vibration element to induce different types of vibration. For example, multiple offset weights 410, 510, or 610 may be mounted in parallel along rotary shaft 320.

One of ordinary skill in the art will recognize that different embodiments may have different arrangements of offset weights and/or differently shaped or sized offset weights than those shown herein. Although the various offset weights 410, 510, and/or 610 are shown as being mounted outside the housing of vibration element 230, in some embodiments, such offset weights may be mounted along the rotary shaft 320 and within the housing for improved safety, reliability, etc.

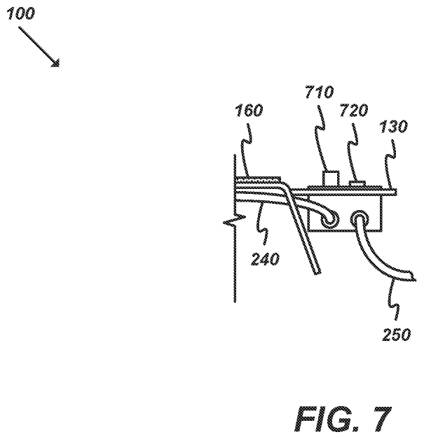

FIG. 7 illustrates a closeup side elevation view of a portion of the vibration platform 100. As shown, UI element 150 may include a rotary control 710 and a pushbutton 720.

As shown, the platform manager 140 may be mounted along the skirt of housing 110. The housing of platform manager 140 may include metal for durability, plastic for lightweight applications, and/or other appropriate materials.

Rotary control 710 may be an example UI element 150 that may allow selection from among a range of settings (e.g., vibration frequency, power, etc.). Pushbutton 720 may be an example UI element 150 that may enable or disable operation of the vibration platform 100 or elements thereof. Different embodiments may include various different combinations of UI elements 150 and/or may provide UI features via a user device such as a smartphone.

An element such as rotary control 710 may be used to select among various discrete modes of operation (e.g., exercise, therapy, treatment, etc.). For example, each of a set of available modes may be associated with operating attributes such as vibration frequency, power, duration, etc. Selection of an available mode using a single UI element 150 may then cause the various operating attributes and/or parameters to be updated.

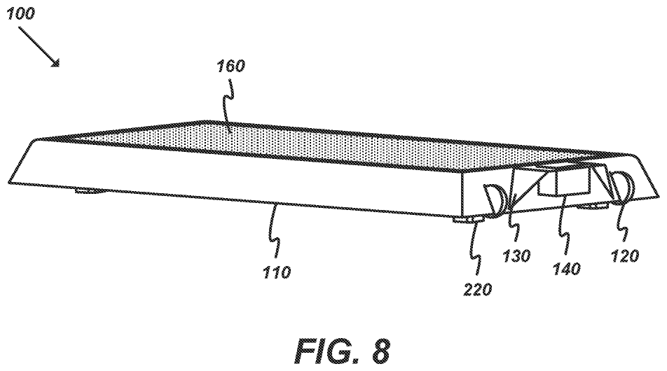

FIG. 8 illustrates a top, front, right-side perspective view of the vibration platform 100. As shown, in this example the platform manager 140 and the wheels 120 for mobility are mounted to one side. Other embodiments may have multiple sets of wheels on any or all sides of the platform. In some cases the vibration platform 100 may not have wheels at all or the wheels 120 may be tucked underneath the platform skirt and out of sight of the user.

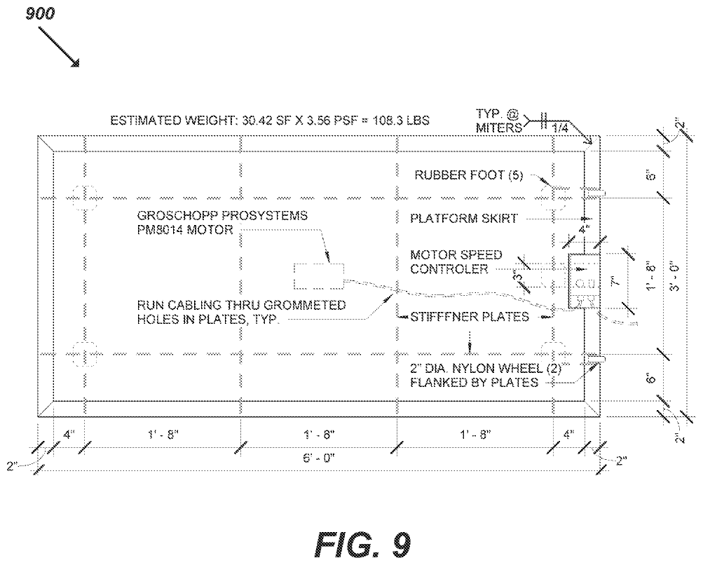

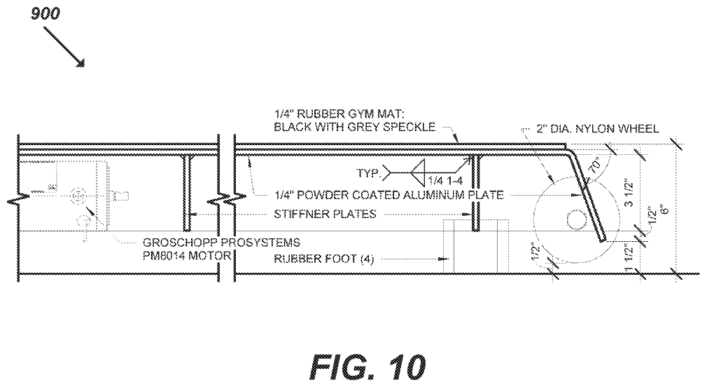

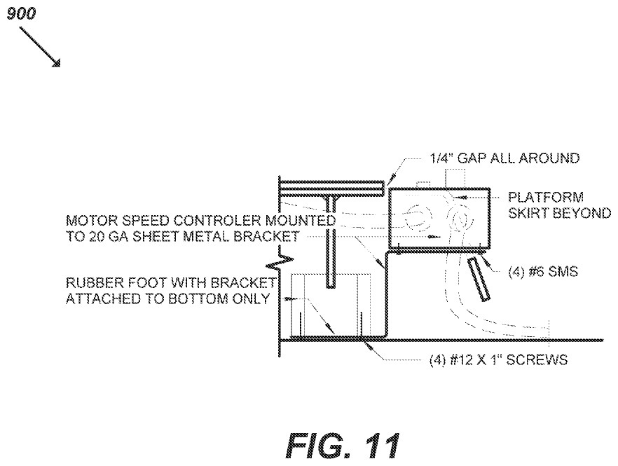

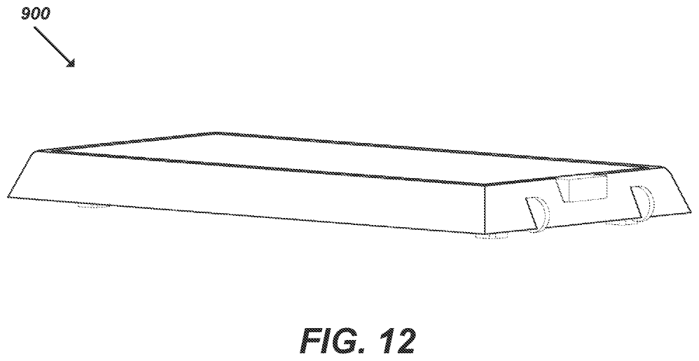

FIG. 9 illustrates a top plan view of another exemplary vibration platform 900. FIG. 10 illustrates a section view of the vibration platform 900. FIG. 11 illustrates a closeup side elevation view of a portion of the vibration platform 900. FIG. 12 illustrates a top, front, right-side perspective view of the vibration platform 900. Vibration platform 900 may be one specific example instantiation of vibration platform 100.

In this specific example, the top deck of the platform may be about sixty-eight inches by thirty-two inches and may support weights up to two thousand pounds. Such platform sizes may allow for full body training. Such weight capacity may allow a user to utilize various types of equipment in conjunction with the vibration platform 100 (e.g., weights, fixtures such as racks or benches, etc.). In this example, the vibration platform 900 may be low-profile with two-inch diameter wheels 120.

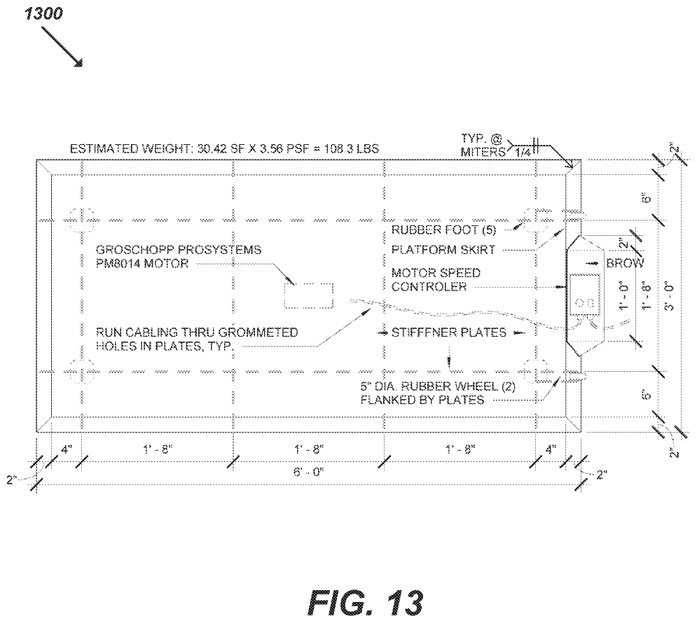

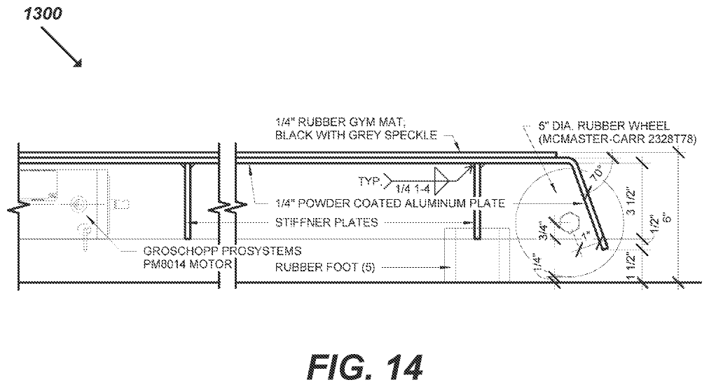

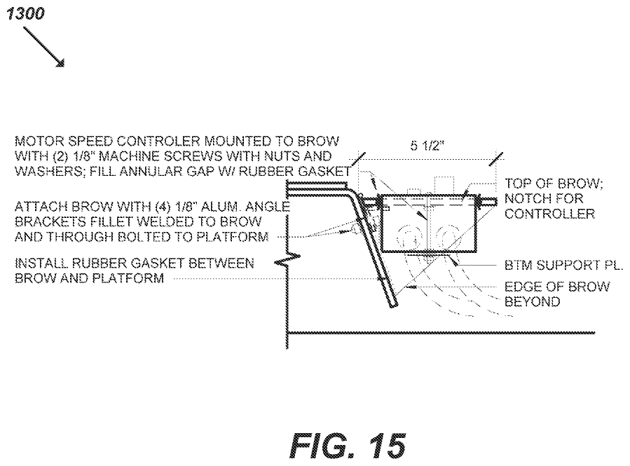

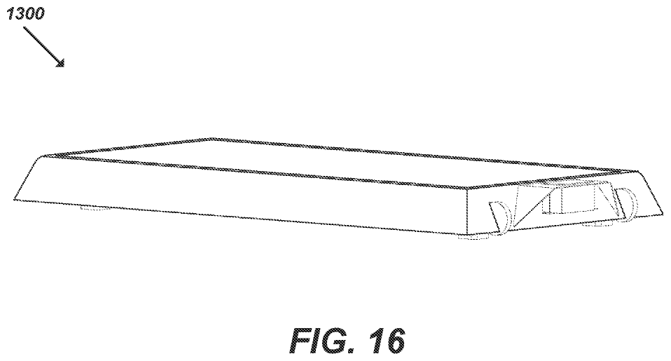

FIG. 13 illustrates a top plan view of another exemplary vibration platform 1300. FIG. 14 illustrates a section view of the vibration platform 1300. FIG. 15 illustrates a closeup side elevation view of a portion of the vibration platform 1300. FIG. 16 illustrates a top, front, right-side perspective view of the vibration platform 1300. Vibration platform 1300 may be one specific example instantiation of vibration platform 100. In this specific example, the vibration platform 1300 may include five-inch diameter wheels 120.

One of ordinary skill in the art will recognize that the example vibration platforms 900 and 1300 are illustrated with various example dimensions, features, etc. for exemplary purposes and that different embodiments of the vibration platform 100 may be associated with various specific dimensions, features, etc.

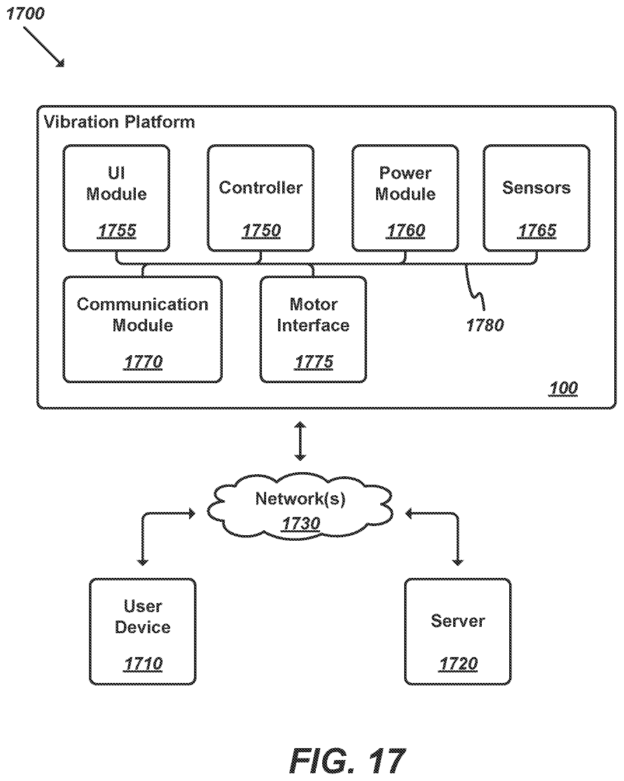

FIG. 17 illustrates a schematic block diagram of an exemplary environment 1700 associated with the vibration platform 100. As shown, the environment 1700 may include the vibration platform 100, one or more user devices 1710, one or more servers 1720, and/or network(s) 1730.

Each user device 1710 may be an electronic device such as a smartphone, tablet, personal computer (PC), wearable device, etc. User device 1710 implement various UI features (e.g., via a smartphone application of some embodiments, via a web portal of some embodiments, etc.) associated with vibration platform 100, such as frequency or power controls, display of parameter values, etc.

User devices 1710 may be associated with various different types of users. For instance, a “training-user” that is physically interacting with a vibration platform 100 may use a user device 1710 to manipulate the control settings of the vibration platform 100. As another example, a trainer, instructor, therapist, physician, other caregivers or practitioners, and/or other similar “trainer-users” may use a user device 1710 to manipulate the control settings of a vibration platform and/or to interact with a training user (e.g., via a display screen, microphone, speaker, etc. of the user device 1710) during a training session. Such “training sessions” may include, for instance, fitness training, physical therapy, physical rehabilitation, patient or subject evaluation, and/or other appropriate activities where a vibration platform may be utilized. As another example, media content (e.g., training or instructional videos available through a web-based portal or application) provided via a user device 1710 may be synchronized to various operating parameter adjustments automatically applied at the vibration platform (e.g., a frequency or power setting may be modified based on progress or elapsed time through a training regimen).

One of ordinary skill in the art will recognize that any functionality described in relation to a user device 1710 may be at least partially implemented at the vibration platform 100 (e.g., via UI elements 150 such as display screens, speakers, microphones, touchpads, etc.).

Each server 1720 may be an electronic device or set of devices that may provide access to various resources, such as firmware, user device applications, web-based resources, etc. In some embodiments, server 1720 may be associated with, or provide access to, a resource such as a storage or database (e.g., via an application programming interface (API)).

Networks 1730 may include local and distributed communication channels, such as Bluetooth, Wi-Fi, ethernet, the Internet, cellular networks, etc. that may allow communication among any number of vibration platforms 100, user devices 1710, servers 1720, and/or other components or systems.

As shown, the vibration platform 100 may include a controller 1750, a UI module 1755, a power module 1760, sensors 1765, a communication module 1770, a motor interface 1775, a communication bus 1780, and/or other appropriate components. In some embodiments, the various modules and/or elements 1750-1780 may be associated with a resource such as platform manager 140 (e.g., the various components may be included in a single housing or a set of housings).

Controller 1750 may be, include, and/or utilize an elements such as a microcontroller, processor, dedicated logic circuitry, and/or other appropriate elements that may be able to receive operating attributes or parameters and apply the parameters to various operations of the vibration platform 100. Controller 1750 may be able to execute instructions and/or otherwise process data. Controller 1750 may be associated with one or more local or remote storages (not shown) that may be able to receive, store, and/or provide various data and/or instructions.

UI module 1755 may include, provide, and/or utilize various interfaces, protocols, etc. that may allow inputs to be received via various UI elements 150 and/or outputs to be provided via such UI elements 150. For example, some embodiments of the vibration platform 100 may include a rotary power control 710 and an output display indicating a current power level (e.g., on a relative scale from one to ten).

UI Module 1755 may interact with user device 1710 to provide various UI features. For instance, a graphical UI may be provided via a smartphone touchscreen that allows a user to manipulate controls such as power, frequency, duty cycle, duration, etc. and provides the inputs received via such a graphical UI to an element such as a controller 1750 for application at the vibration platform 100. Similarly, data received from controller 1750 may be provided via UI module 1755 to a resource such as user device 1710 (e.g., measured vibration frequency, elapsed time, and/or other operating attributes may be displayed via local UI elements 150 or an elements such as a touchscreen of user device 1710).

Power module 1760 may include various elements associated with power provision and/or management. For instance, power module 1760 may include, utilize, or be associated with elements such as a battery and associated charging port or connector.

Sensors 1765 may include various types of sensors, such as motion detectors (e.g., accelerometers), environmental sensors (e.g., temperature, humidity, etc.), weight sensors (e.g., a “scale” that is able measure load on the top deck of housing 110), and/or other appropriate sensors. Sensors 1765 may be associated with various interfaces, connectors, etc. (not shown) that may allow elements such as controller 1750 to interact with sensors 1765.

Sensors 1765 may include sensors provided by various other devices or systems where data may be received across channels such as network 1730, via communication module 1770. For example, sensors 1765 may include a heart rate monitor (HRM) or other wearable user device 1710 that are able to communicate across wireless channels.

Communication module 1770 may be able to interact with various other components, devices, or systems across various available channels. For example, communication module 1770 may be able to communicate wired connectors (e.g., via a universal serial bus (USB) port, ethernet, etc.), networks 1730, and/or other appropriate pathways.

Motor interface 1775 may include various components such as power drivers, inverters, etc. that are able to operate a resource such as vibration element 230.

Communication bus 1780 may allow communication among the components of vibration platform 100 and may include elements such as wiring or other connective circuitry, wireless communication channels, cables, sockets, connectors, and/or other appropriate elements.

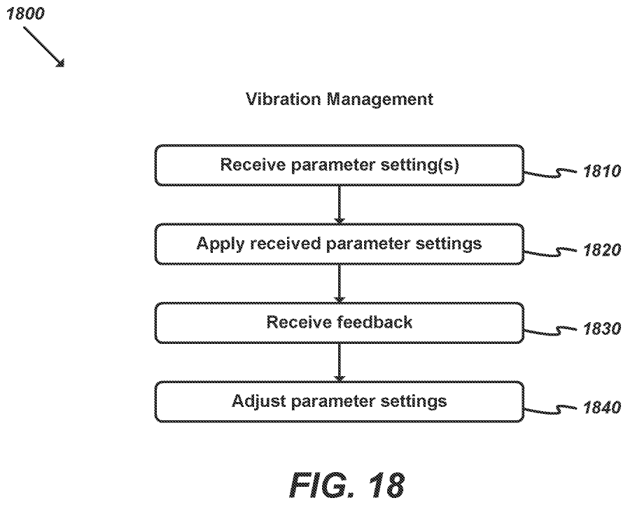

FIG. 18 illustrates an example process 1800 for managing vibration. Process 1800 may receive various operation settings and apply those settings to the vibration platform 100. The process may be performed when a vibration platform 100 is turned on, when power is provided to a vibration platform 100, and/or under other appropriate conditions. In some embodiments, process 1800 may be performed by vibration platform 100 or a component such as platform manager 140.

As shown, process 1800 may include receiving (at 1810) parameter settings. Parameter settings may be received from various appropriate sources in various appropriate ways. For example, settings may be received via UI elements 150 or via a resource such as user device 1710. Parameters may include, for example, vibration speed, vibration frequency, vibration duration, vibration power, vibration duty cycle or waveform, and/or other appropriate parameters.

Process 1800 may include applying (at 1820) the received parameter settings. Such settings may be applied via a resource such as controller 1750 and/or motor interface 1775. For example, controller 1750 may direct motor interface 1775 to increase or decrease power provided to the motor. As another example, controller 1750 may direct motor interface 1775 to generate a control waveform that increases or decreases vibration frequency.

The process may include receiving (at 1830) feedback. Such feedback may be received automatically, via resources such as sensors 1765 and/or based on inputs received via a resource such as UI module 1755. For instance, a set of accelerometers 1765 may be used to measure vibration frequency and such measured data may be provided to a resource such as controller 1750 such that adjustments to control signals may be made via a resource such as motor interface 1775. As another example, a UI element 150 such as a rotary knob may be manipulated by a user to increase or decrease, for example, vibration frequency and such user feedback may be applied via a resource such as controller 1750 such that adjustments to control signals may be made via a resource such as motor interface 1775.

As shown, process 1800 may include adjusting (at 1840) parameter settings based on the received feedback. Such settings may be applied via a resource such as controller 1750 and/or motor interface 1775 as described above in reference to operation 1820. Operations 1830-1840 may be performed iteratively while the vibration platform 100 is in use.

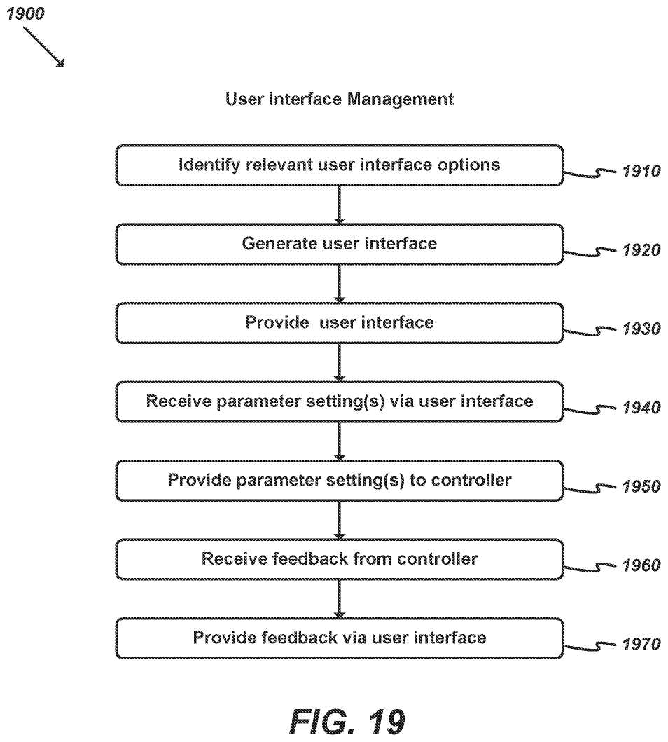

FIG. 19 illustrates an example process 1900 for providing UI features. The process may allow user inputs to be received and feedback to be provided to the user. The process may be performed during operation of the vibration platform 100. In some embodiments, process 1900 may be performed by vibration platform 100 or a component such as platform manager 140.

As shown, process 1900 may include identifying (at 1910) relevant UI options. Options may be identified in various appropriate ways. For instance, an element such as controller 1750 may poll available UI features (e.g., by sending a set of messages to UI module 1755, by interacting with a user device 1710 via communication module 1770, etc.). In some cases, a lookup table or similar resource may be utilized to identify relevant device options. For example, a request may be sent via communication module 1770 to a resource such as server 1720, where the request may include information such as a unique identifier (e.g., a serial number) of the vibration platform 100, user device 1710, and/or other relevant components. The request may be matched to a device or device type and an associated set of available UI resources. As one example, the vibration platform 100 may be associated with a set of UI features (e.g., a rotary control, a pushbutton, and a display) provided via UI elements 150, where such features and/or elements are listed in a lookup table. As another example, UI capabilities may be requested in a message from vibration platform 100, via communication module 1770 and network 1730 to a resource such as user device 1710, where the user device 1710 may respond with a listing of UI features.

In some embodiments, a profile or other data structure may be associated with each user, vibration platform 100, user device 1710, and/or other appropriate device or system elements. Thus, for instance, a user may save preferences related to which UI features should be provided, depending on which device(s) are available (e.g., the user may prefer a first set of features if no user device 1710 is connected and a second set of features when a user device is connected). As another example, each user may set boundaries for setting values such that a first user may be able to select from a range of option with higher power or frequency than those available to a second user. As still another example, if a particular user is identified (e.g., via a connected user device 1710), a routine or program may be automatically selected or started based on the user profile.

Process 1900 may include generating (at 1920) a UI. Such generation may depend on the types of UI elements 150 provided by the vibration platform 100 and/or external devices (e.g., user device 1710) that may be available. For instance, if UI elements 150 include a pushbutton, rotary control, and display, UI generation may include generating control signals for the display based on the pushbutton and rotary control positions (and/or other relevant information, such as sensor readings). As another example, if the UI elements 150 include a touchscreen display, and/or if a user device 1710 with a touchscreen display is in communication with the vibration platform 100, a complete graphical UI may be generated, including virtual indicators, buttons or other inputs, and/or any other features that may be provided via a graphical UI. Generating a graphical UI may include, for instance, rendering a web page or portal, providing data to an application of some embodiments, and/or otherwise formatting data for provision via the available UI features (e.g., by scaling a received or measured value for display via a two-digit output).

The process may include providing (at 1930) the UI. Provision of the UI may depend on the available UI elements 150, connected devices, and/or other relevant factors. For instance, a web-based UI may be sent, as hypertext markup language (HTML) code, from vibration platform 100 to a user device 1710 via communication module 1770 and network 1730. As another example, controller 1750 may send control signals or messages to a resource such as a display 150 provided by the vibration platform 100.

As described above, in some cases instructional videos and/or other media may be associated with usage of the vibration platform 100. Such media may be synchronized (e.g., via a timeline or similar feature) with operation(s) of the vibration platform 100, such as UI generation and provision. For example, if parameter settings are associated with the synchronized media (e.g., vibration frequency may be increased or decreased as the instruction progresses), the UI may be updated to reflect such updates. As another example, various options may be provided via a UI during media presentation (e.g., a prompt whether to “increase intensity?” may be provided).

As shown, process 1900 may include receiving (at 1940) parameter settings via one or more UI features (e.g., UI elements 150, a UI provided via a user device 1710, etc.) and/or other appropriate interfaces (e.g., communication module 1770 may receive settings from a server 1720 via network 1730, signals received via sensors 1765 may be analyzed by controller 1750 to determine or identify parameter updates, etc.).

Example parameter updates may include vibration levels (e.g., power, speed, waveform, duty cycle, etc.), timers, intervals, exercise modalities (e.g., fitness training, high intensity interval training (HIIT), strength training, cardiovascular training, power training, yoga, stretching exercises, meditation exercises, sport-specific training, athletic exercises, martial arts training, etc.), and/or other relevant parameter updates. Parameter updates may include updates to user information (e.g., user weight, height, etc.), equipment information (e.g., type, weight or load, etc.), and/or other relevant information related to usage of the vibration platform 100.

Process 1900 may include providing (at 1950) the received parameter settings to a controller. As above, the UI module 1755 may provide received settings to a resource such as controller 1750.

The process may include receiving (at 1960) feedback from the controller. Such feedback may include, for instance, data provided by sensors 1765 via controller 1750. In some cases, feedback may be provided via motor interface 1775 (e.g., motor speed or other parameters may be measured at the vibration element 230 and provided to the controller 1750 via motor interface 1775).

As shown, process 1900 may include providing (at 1970) feedback via one or more UI elements. Such feedback may include, for example, measured data (e.g., speed or frequency measured by sensors 1755), usage information (e.g., session duration, platform eight load, etc.).

One of ordinary skill in the art will recognize that processes 1800-1900 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

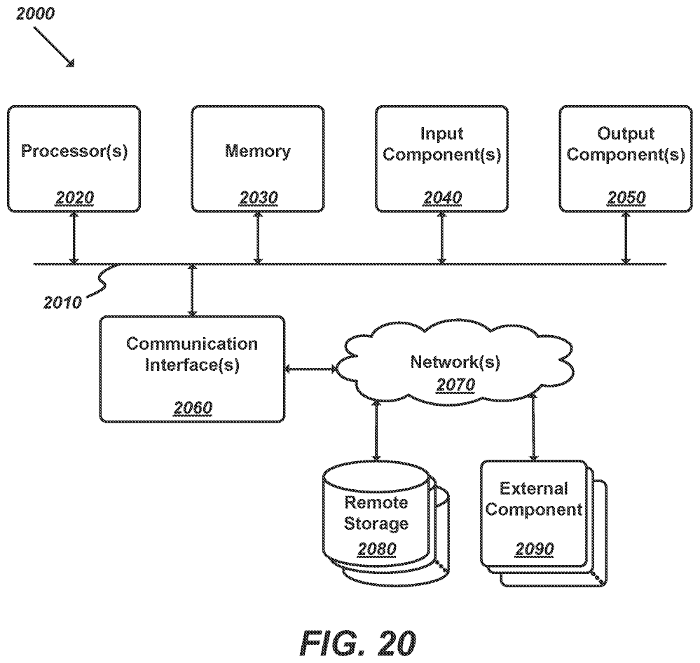

FIG. 20 illustrates a schematic block diagram of an exemplary device (or system or devices) 2000 used to implement some embodiments. For example, the systems, devices, components, and/or operations described above in reference to FIG. 1-FIG. 17 may be at least partially implemented using device 2000. As another example, the processes described in reference to FIG. 18 and FIG. 19 may be at least partially implemented using device 2000.

Device 2000 may be implemented using various appropriate elements and/or sub-devices. For instance, device 2000 may be implemented using one or more personal computers (PCs), servers, mobile devices (e.g., smartphones), tablet devices, wearable devices, and/or any other appropriate devices. The various devices may work alone (e.g., device 2000 may be implemented as a single smartphone) or in conjunction (e.g., some components of the device 2000 may be provided by a mobile device while other components are provided by a server).

As shown, device 2000 may include at least one communication bus 2010, one or more processors 2020, memory 2030, input components 2040, output components 2050, and one or more communication interfaces 2060.

Bus 2010 may include various communication pathways that allow communication among the components of device 2000. Processor 2020 may include a processor, microprocessor, microcontroller, DSP, logic circuitry, and/or other appropriate processing components that may be able to interpret and execute instructions and/or otherwise manipulate data. Memory 2030 may include dynamic and/or non-volatile memory structures and/or devices that may store data and/or instructions for use by other components of device 2000. Such a memory device 2030 may include space within a single physical memory device or spread across multiple physical memory devices.

Input components 2040 may include elements that allow a user to communicate information to the computer system and/or manipulate various operations of the system. The input components may include keyboards, cursor control devices, audio input devices and/or video input devices, touchscreens, motion sensors, etc. Output components 2050 may include displays, touchscreens, audio elements such as speakers, indicators such as light-emitting diodes (LEDs), printers, haptic or other sensory elements, etc. Some or all of the input and/or output components may be wirelessly or optically connected to the device 2000.

Device 2000 may include one or more communication interfaces 2060 that are able to connect to one or more networks 2070 or other communication pathways. For example, device 2000 may be coupled to a web server on the Internet such that a web browser executing on device 2000 may interact with the web server as a user interacts with an interface that operates in the web browser. Device 2000 may be able to access one or more remote storages 2080 and one or more external components 2090 through the communication interface 2060 and network 2070. The communication interface(s) 2060 may include one or more APIs that may allow the device 2000 to access remote systems and/or storages and also may allow remote systems and/or storages to access device 2000 (or elements thereof).

It should be recognized by one of ordinary skill in the art that any or all of the components of computer system 2000 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 2000 may perform various operations in response to processor 2020 executing software instructions stored in a computer-readable medium, such as memory 2030. Such operations may include manipulations of the output components 2050 (e.g., display of information, haptic feedback, audio outputs, etc.), communication interface 2060 (e.g., establishing a communication channel with another device or component, sending and/or receiving sets of messages, etc.), and/or other components of device 2000.

The software instructions may be read into memory 2030 from another computer-readable medium or from another device. The software instructions stored in memory 2030 may cause processor 2020 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A vertical vibration platform comprising:
a vibration plate;
a motor coupled to the vibration plate; and
a controller coupled to the motor.

2. The vertical vibration platform of claim 1, wherein the motor comprises a rotary shaft and an offset weight coupled to the rotary shaft.

3. The vertical vibration platform of claim 2, wherein the offset weight comprises a cylindrical connector coupled to a cylindrical disk.

4. The vertical vibration platform of claim 1, wherein the vibration plate is coupled to a frame comprising a lattice of linear stiffener plates.

5. The vertical vibration platform of claim 4, wherein the frame is coupled to a plurality of supports able to retain the vertical vibration platform on a flat surface.

6. The vertical vibration platform of claim 5, wherein at least one support from the plurality of supports has an adjustable height.

7. The vertical vibration platform of claim 1 further comprising a set of wheels coupled to the vibration plate.

8. A vibration platform comprising:
a frame having a lattice of parallel and perpendicular structural members;
a housing coupled to the frame;
a vibration element coupled to the housing; and
a controller communicatively coupled to the vibration element.

9. The vibration platform of claim 8, wherein the controller comprises a set of user interface (UI) elements.

10. The vibration platform of claim 9, wherein the set of UI elements comprises a rotary control and a display.

11. The vibration platform of claim 8, wherein the frame and housing comprise one-quarter inch thick aluminum sheet metal.

12. The vibration platform of claim 8, wherein the vibration element comprises a rotary motor coupled to an offset weight.

13. The vibration platform of claim 8, wherein the controller comprises a wireless communication module able to communicate across a local wireless channel.

14. The vibration platform of claim 8, wherein the housing comprises a rectangular top deck.

15. A method of operating a vibration plate comprising:
receiving a vibration power setting via a first user interface (UI) element of the vibration plate;
adjusting power provided to a motor of the vibration plate based at least partly on the received vibration power setting; and
providing an indication of the vibration power setting via a second UI element of the vibration plate.

16. The method of claim 15 further comprising:
receiving an updated vibration power setting via the first UI element;
adjusting power provided to the motor based at least partly on the updated vibration power setting; and
providing an indication of the updated vibration power setting via the second UI element.

17. The method of claim 15, wherein the first UI element comprises a rotary control and the second UI element comprises a display screen.

18. The method of claim 15 further comprising:
establishing a wireless communication channel with a user device;
receiving an updated vibration power setting via the user device;
adjusting power provided to the motor based at least partly on the updated vibration power setting; and
providing an indication of the updated vibration power setting via the user device.

19. The method of claim 15 further comprising:
receiving a vibration frequency setting via the first UI element of the vibration plate;
adjusting control signals provided to a motor of the vibration plate based at least partly on the received vibration frequency setting; and
providing an indication of the vibration frequency setting via the second UI element of the vibration plate.

20. The method of claim 15, wherein the first UI element comprises a rotary control and the second UI element comprises a display.
